(19) United States
(12) Patent Application Publication
(10) Pub. No.: US 2026/0027958 A1
(43) Pub. Date: Jan. 29, 2026

(54) SEAT AND METHOD FOR ASSEMBLING THE SAME

(71) Applicant: TOYOTA BOSHOKU KABUSHIKI KAISHA, Aichi (JP)

(72) Inventors: Naoki MITSUOKA, Miyoshi-shi, Aichi-ken (JP); Yukinori SUGIURA, Nisshin-shi, Aichi-ken (JP); Kenichi TSUKAMOTO, Okazaki-shi, Aichi-ken (JP); Takashi SAKAGUCHI, Tokoname-shi, Aichi-ken (JP); Akihisa MIYATA, Toyota-shi, Aichi-ken (JP)

(73) Assignee: TOYOTA BOSHOKU KABUSHIKI KAISHA, Aichi (JP)

(21) Appl. No.: 19/119,632

(22) PCT Filed: Oct. 12, 2023
(86) PCT No.: PCT/JP2023/037010

§ 371 Date: Apr. 9, 2025

(30) Foreign Application Priority Data
Oct. 18, 2022 (JP) 2022-166733

(51) Int. Cl. B60N 2/72; B60N 2/68

(52) U.S. Cl. CPC B60N 2/72; B60N 2/682

(57) ABSTRACT

A seat has a cushion body divided into three parts: a main top panel and two side top panels. Each side top panel has a side top panel resin member disposed on the back side of its pad. Fastening brackets extend from respective tilt arms of the cushion frame. The side top panel resin members are overlaid on the fastening brackets and fastened by a plug-in type fastening structure. Each plug-in type fastening structure has a head of a bolt that is engaged with a fastening tool. The head is exposed in the opening, which is an installation space for the main top panel.

### CROSS-REFERENCE TO RELATED APPLICATIONS

The present application is a 35 U.S.C. § 371 U.S. National Phase entry of, and claims priority to, PCT Application PCT/JP2023/037010 filed Oct. 12, 2023, which claims priority to Japanese Patent Application No. 2022-166733 filed Oct. 18, 2022, which is hereby incorporated herein by reference in its entirety for all purposes.

### BACKGROUND

One aspect of the present disclosure relates to a seat and a method for assembling the seat. More particularly, it relates to a seat having a cushion body that elastically supports a seater and a seat frame that supports the cushion body from a back side of the seat, and a method for assembling the same.

JP2020-33005A discloses a configuration of a vehicle seat in which a cushion body having a seat pad and a seat cover is configured to be divided into three parts in a seat width direction. Specifically, the cushion body is divided into three parts such as a main top panel, which forms the center portion in the seat width direction, and respective side top panels, which form two side portions in the seat width direction. The main top panel and each side top panel are individually assembled and fixed to a seat frame, respectively.

In the configuration described in JP2020-33005A, the main top panel and respective side top panels are fixed to the seat frame by bolt-fastening, respectively. More specifically, after the side top panels are secured, the main top panel is assembled to the seat frame. The main top panel is fixed to the seat frame by nuts that are tightened from a back side of the seat. The seat is mounted on a vehicle. When the main top panel and each side top panel need to be removed from the seat frame, the seat must be removed from the vehicle once. In this state, the main top panel and each side top panel are unfastened with respect to the seat frame from the back side of the seat. Therefore, there has been a need for a seat in which a cushion body can be easily attached to and removed from a seat frame.

### SUMMARY

One aspect of the present disclosure is a seat having a cushion body that elastically supports a seater and a seat frame that supports the cushion body from a back side of the seat. The cushion body includes three separate elements divided into a main top panel that forms a center portion in a seat width direction and respective side top panels that form two side portions in the seat width direction. Each of the side top panels has a side top panel pad that serves as a cushioning portion and a support member. The support member is disposed on the back side of the side top panel pad and is fixed to the seat frame. The seat frame has respective side frames supporting each of the side top panels from the back side of the seat and respective frame fastening portions. The support member is overlaid on the frame fastening portion and the support member is fastened to the frame fastening portion via a plug-in type fastening structure. The main top panel is snap-fitted to the seat frame, making it easy to attach and remove. This snap-fitting mechanism allows the main top panel to be easily attached and removed from the seat frame, providing both stability and convenience. In a main top panel removed state with the main top panel removed from the seat frame, an opening, which is an installation space for the main top panel, is created. A tool engaging portion of the plug-in type fastening structure is exposed through the opening, allowing easy access for a fastening tool to engage and operate the fastening mechanism.

As described above, the main top panel is snap-fitted to the seat frame. Therefore, the main top panel can be removed from the seat frame relatively easily. An installation space for the main top panel is created when the main top panel is removed from the seat frame. The tool engaging portion of the plug-in type fastening structure is exposed in the opening. Therefore, each side top panel may be attached to or removed from each side frame using this opening as a workspace. For example, each side top panel may be easily attached and removed without removing the seat from a floor or other object on which it is to be installed.

According to another aspect of the present disclosure, each of the frame fastening portions extends diagonally backward from each of the corresponding side frames to an inner side in the seat width direction. Each of the frame fastening portions has an overlapping surface on which the support member is laid on. The direction perpendicular to the overlapping surface is oriented towards the opening.

There is a configuration in which a support spring is provided between the seat frames to support the cushion body. In this configuration, it is difficult to lower the fastening tool down between the seat frames. Even in such a configuration, the above configuration allows for easy attachment and removal of each side top panel.

According to another aspect of the present disclosure, an engagement hole is formed in the side frame. The support member further includes an engagement claw that is inserted into the engagement hole and slidably moved so as to be hooked to the side frame. The engagement claw is hooked to the side frame so that the plug-in type fastening structure can allow the support member to be fastened to each of the frame fastening portions. The side top panels are fastened to the frame using the plug-in-type fastening structure, which includes bolts and engagement claws. This configuration allows for easy assembly and disassembly without removing the seat from the vehicle.

As described above, the side top panels are assembled to the side frames by hooking of the engagement claw by sliding and fastening with the plug-in type fastening structure. Compared to a configuration assembled by snap-fitting that involves elastic deformation, each side top panel can be easily assembled to each side frame with proper assembly strength. Also, each side top panel can be easily removed from each side frame.

According to another aspect of the present disclosure, the tool engaging portion has a head of a bolt. The head is located on a side of each plug-in type fastening structure closest to the opening.

According to the above-described configuration, a shaft of the bolt is not oriented to the opening. Therefore, the bolt provided in the cushioning body is less likely to be perceived as a foreign object.

According to another aspect of the present disclosure, the main top panel has fitting claws that are designed to snap-fit into a base portion of the seat frame. These fitting claws are located on the main top panel resin member. The fitting claw is removably snap-fitted to a base portion upon being pressed from a front side of the seat. The base portion is provided to be integral with the seat frame. The main top panel meets the seat frame from the front side of the seat. The fitting claws engage with the base portion integral to the seat frame, securing the main top panel in place.

Therefore, the main top panel can be easily attached to and removed from the seat frame.

Another aspect of the present disclosure relates to an assembly method for assembling a seat. Each of the support members on each of the side top panel is laid on each of the corresponding frame fastening portions. Each of the support members is assembled to the seat frame by fastening each of the plug-in type fastening structures (side top panel assembling process). The main top panel is assembled to the seat frame (main top panel assembling process).

As described above, the side top panel assembling process is performed before the main top panel assembling process. Therefore, the opening, which serves as an installation space for the main top panel, may be used as a workspace. The opening can be used to easily assemble each side top panel to the seat frame.

### BRIEF DESCRIPTION OF DRAWINGS

FIG. 1 is a perspective view illustrating a schematic configuration of a seat according to the a embodiment.

FIG. 2 is a side view of a seat cushion.

FIG. 3 is a plan view of the seat cushion.

FIG. 4 is an exploded perspective view with a cushion body removed from a cushion frame.

FIG. 5 is a plan view of the cushion frame.

FIG. 6 is a bottom view of the cushion body.

FIG. 7 is a cross-sectional view taken along line VII-VII in FIG. 3.

FIG. 8 is a cross-sectional view taken along line VIII-VIII in FIG. 3.

FIG. 9 is an enlarged view of section IX in FIG. 8.

FIG. 10 is a cross-sectional view taken along line X-X in FIG. 3.

FIG. 11 is a perspective view illustrating a state before one side top panel is assembled to a side frame.

FIG. 12 is a perspective view illustrating a state when one side top panel is assembled to the side frame.

FIG. 13 is a cross-sectional view taken along line XIII-XIII in FIG. 12.

### DETAILED DESCRIPTION

Hereinafter, embodiments for carrying out one aspect of the present disclosure will be described with reference to the drawings.

### First Embodiment

### [Schematic Configuration of Seat 1]

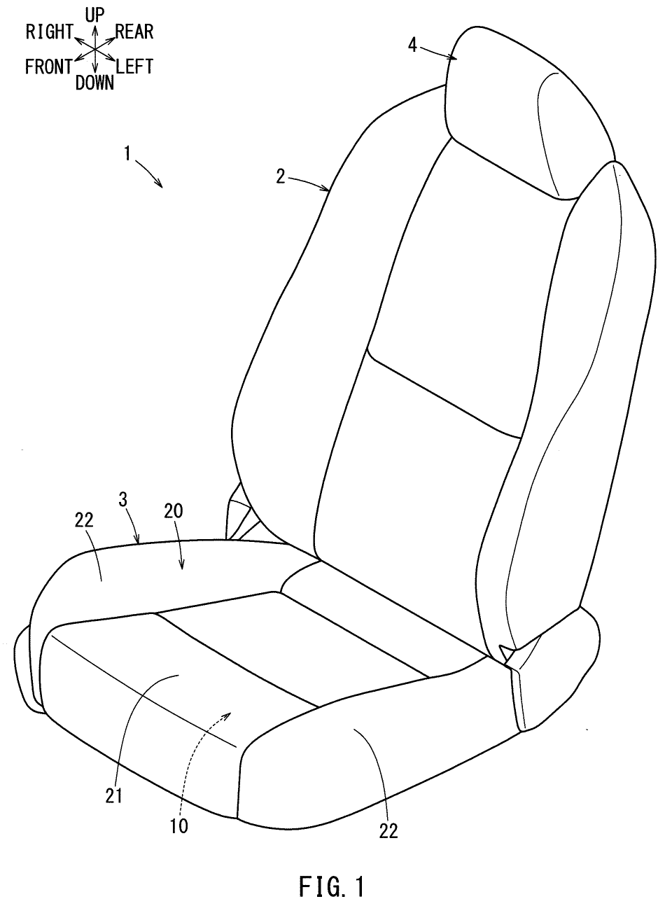

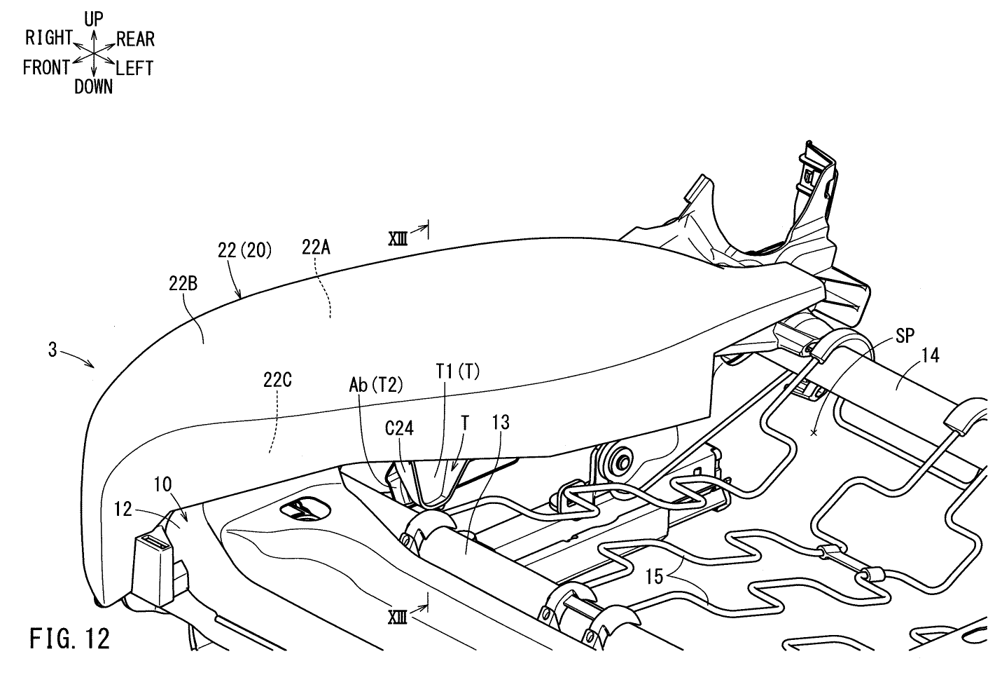

A configuration of the seat 1 according to the first embodiment will be described with reference to FIG. 1 to FIG. 13. In the following description, each direction such as a front-rear, up-down, left-right direction is indicated in each figure. When “seat” is appended to each direction, such as “seat width direction,” it shall refer to the direction based on an orientation of the seat 1 as will be described below. In the following description, when a specific reference figure is not mentioned or when there is no corresponding reference numeral in the reference figure, one of the figures from FIG. 1 to FIG. 13 shall be referred to as appropriate.

As shown in FIG. 1, the seat 1 according to the present embodiment is configured as a right-side seat for one person installed on the floor of an automobile. The seat 1 is provided with a seat back 2 that forms a back resting portion for a seater, a seat cushion 3 that forms a seating portion, and a headrest 4 that forms a head resting portion.

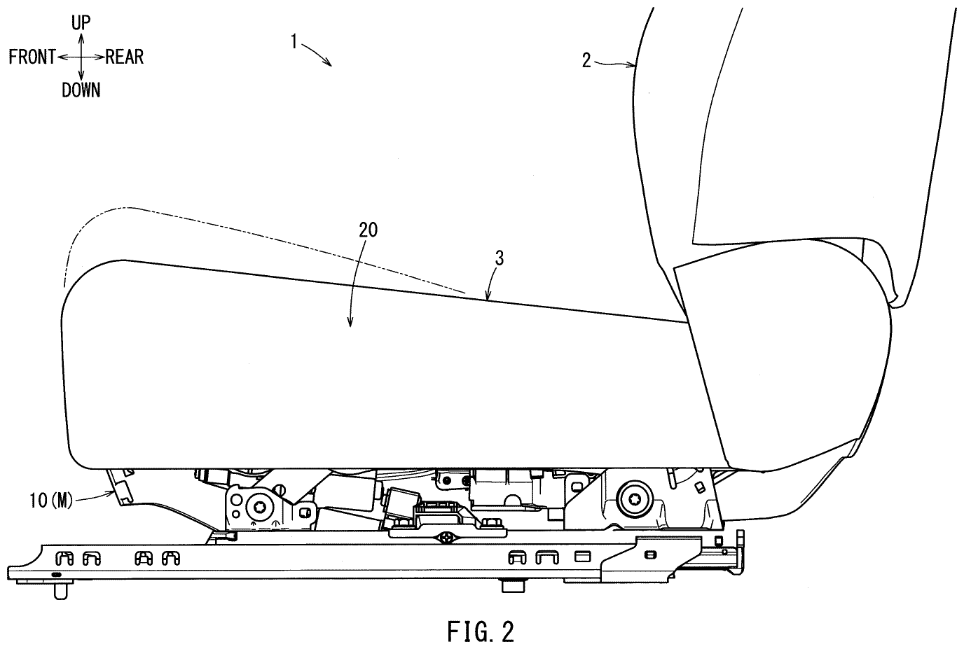

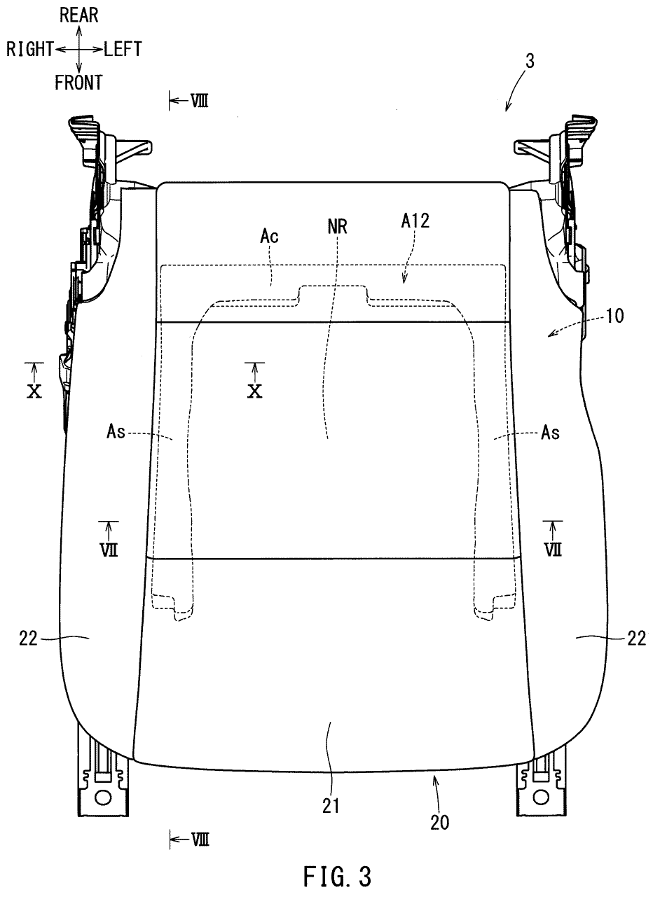

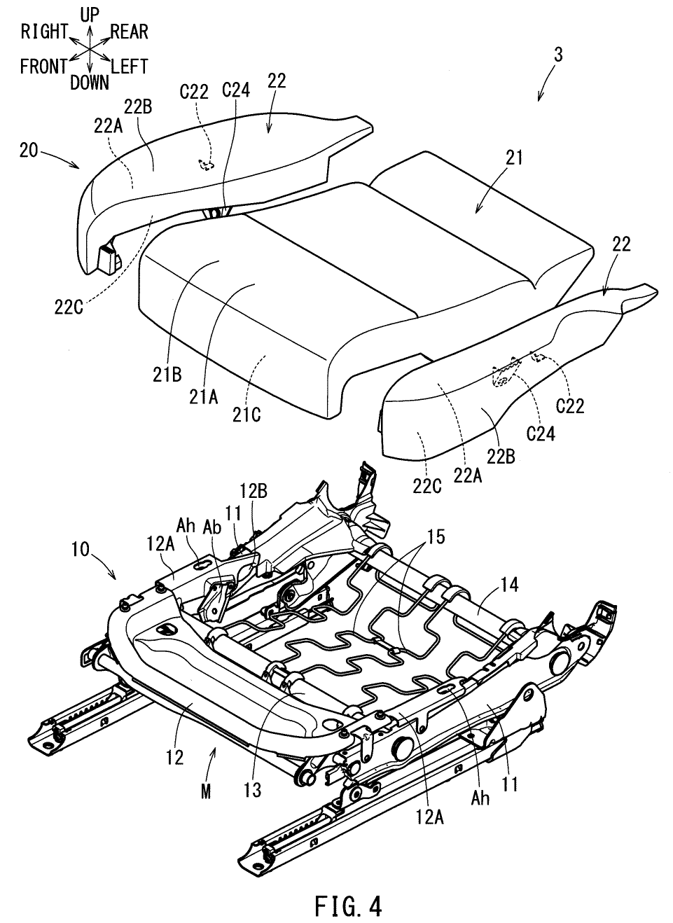

As shown in FIG. 2, the seat cushion 3 has a tilt mechanism M that can adjust a seat angle of a front portion of the seat. As shown in FIG. 3 and FIG. 4, the seat cushion 3 has a metal cushion frame 10, which forms its framework, and a cushion body 20. The cushion body 20 is assembled to an upper portion of the cushion frame 10 and elastically supports buttocks and thighs of the seater. The cushion frame 10 corresponds to one of the “seat frames.”

As shown in FIG. 4, the cushion body 20 includes three separate elements divided into a main top panel 21 that forms the center portion in the seat width direction and respective side top panels 22 that form two side portions in the seat width direction. The main top panel 21 supports the buttocks and thighs of the seater from below. The main top panel 21 has a substantially flat planar shape that faces upward of the seat. The upper surface of the main top panel 21, which is the front side of the seat, is tilted slightly upward at the front.

As shown in FIG. 1, each side top panel 22 supports the buttocks and thighs of the seater from diagonally downward and outward. Each side top panel 22 has an upper surface that serves as its front side of the seat. The upper surface rises diagonally outward in the seat width direction.

As shown in FIG. 4, the main top panel 21 and each side top panel 22 are each configured to be individually assembled to the cushion frame 10 only upon access from above. Thereby, the main top panel 21 and each side top panel 22 can be easily attached to and removed from the cushion frame 10 without removing the seat 1 installed on the floor.

### [Configuration of Seat Cushion 3]

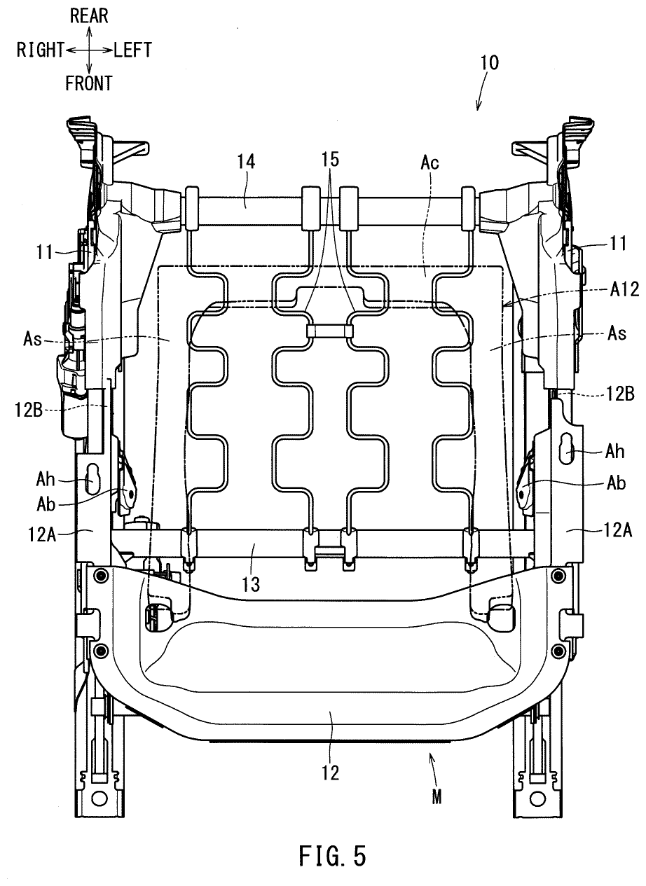

Hereinafter, a specific configuration of each part of the seat cushion 3 will be described. As shown in FIG. 4 and FIG. 5, the cushion frame 10 has left and right lower arms 11 extending in a front-rear direction along both left and right sides of the seat cushion 3. The cushion frame 10 also has a tilt panel 12 planarly extending between front ends of the left and right lower arms 11. The cushion frame 10 also has right and left tilt arms 12A extending from both right and left edges of the tilt panel 12 to the rear of the seat.

A rear end of each tilt arm 12A is connected to an intermediate portion of each corresponding lower arm 11 so as to be rotatable by a tilt rotation shaft 12B extending in the seat width direction. Each tilt arm 12A is tilted in an up-down direction around each tilt rotation shaft 12B via a drive unit (not shown) assembled to the cushion frame 10.

The tilt panel 12 moves up and down relative to each lower arm 11 due to a tilting in an up-down direction of each tilt arm 12A, causing an angle of the tilt panel 12 to change. As a result, a seat angle of a front portion of the seat of the seat cushion 3 is adjusted. The tilt mechanism M mentioned above is configured by the mechanism that allows the angle of the tilt panel 12 relative to each lower arm 11 to be adjusted.

The cushion frame 10 further has a front pipe 13 and a rear pipe 14. The front pipe 13 is a round pipe and is bridged between front parts of each lower arm 11. The front pipe 13 is located behind and below the tilt panel 12. The rear pipe 14 is a round pipe and is bridged between rear parts of each lower arm 11.

As shown in FIG. 4 and FIG. 5, a plurality of (e.g., four) support springs 15 are bridged between the front pipe 13 and the rear pipe 14 of the cushion frame 10. The support springs 15 are bent in a wavy pattern in the front-rear and left-right directions (seat width direction). The support springs 15 elastically support the main top panel 21 of the cushion body 20 from below. Even in configuration where it is difficult to lower the fastening tool down between the seat frames, the support springs 15 allow for easy attachment and removal of each side top panel 12.

As shown in FIG. 4, each tilt arm 12A has an inverted L-shaped arm shape in cross section. The tilt arm 12A has a side plate portion covering an inner surface of the lower arm 11 and a top plate portion covering an upper surface of the lower arm 11. A plate-shaped fastening bracket Ab is welded to a lower part of the side plate portion of the tilt arm 12A, which extends diagonally downward toward the inside of the seat width direction. Each tilt arm 12A corresponds to a “side frame” of the present disclosure, respectively. Each fastening bracket Ab corresponds to a “frame fastening portion” of the present disclosure.

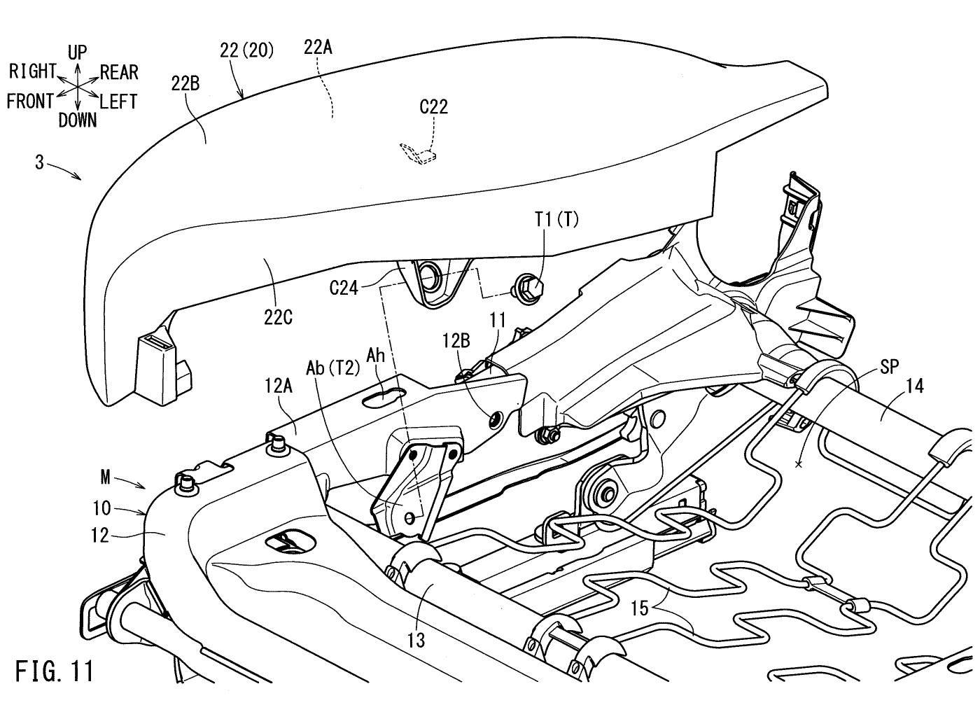

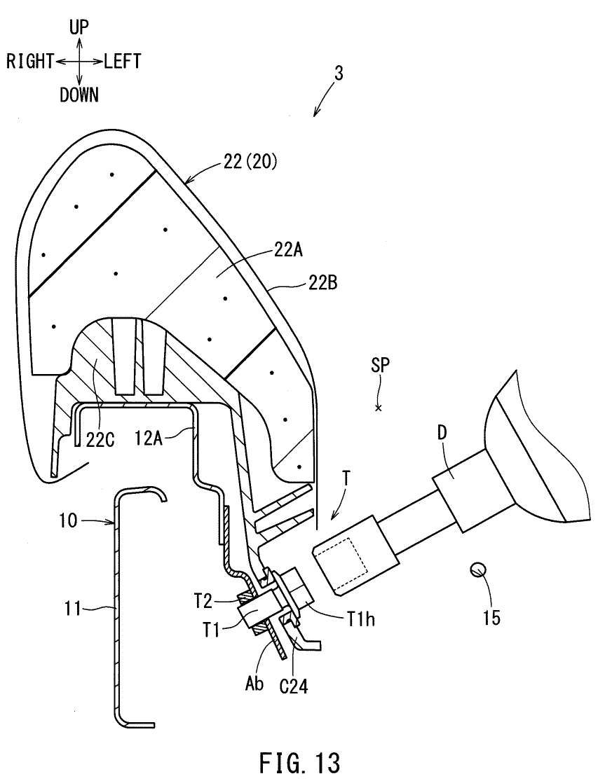

As shown in FIG. 4 and FIG. 5, each fastening bracket Ab is positioned behind and below the front pipe 13. More specifically, each fastening bracket Ab is positioned lower than a support spring 15. Each of the fastening brackets Ab has an upper surface (overlapping surface) facing diagonally inward and upward. The upper surface faces the installation space for the main top panel 21. As shown in FIG. 13, the fastening brackets Ab are located directly below the inner portion of the side top panel 22. On the back side of the seat of the side top panel 22, a side top panel resin member 22C is provided. As shown in FIG. 11, a fastening portion C24 extends from the side top panel resin member 22C. The fastening portion C24 is fastened to the fastening bracket Ab via a fastening structure T.

As shown in FIG. 11, the top plate portion of each tilt arm 12A has a keyhole-shaped engagement hole Ah extending in the seat front-rear direction. These engagement holes Ah are engaged with engagement claws C22 formed on each corresponding side top panel 22. Specifically, the engagement claw C22 is formed on the side top panel resin member 22C provided on the back side of the seat of each side top panel 22. The engagement claw C22 is inserted into the engagement hole Ah in the tilt arm 12 and slidably moved to hook the peripheral edge of the engagement hole Ah. Each side top panel resin member 22C corresponds to a “support member” of the present disclosure.

### [Configuration of Main Top Panel 21]

As shown in FIG. 4 and FIG. 6 to FIG. 8, the main top panel 21 has a main top panel pad 21A that serves as a cushioning portion, a main top panel cover 21B, and a main top panel resin member 21C. The main top panel cover 21B is made of fabric, covering the main top panel pad 21A. The main top panel resin member 21C is provided at the front of the back side of the pad on the main top panel pad 21A.

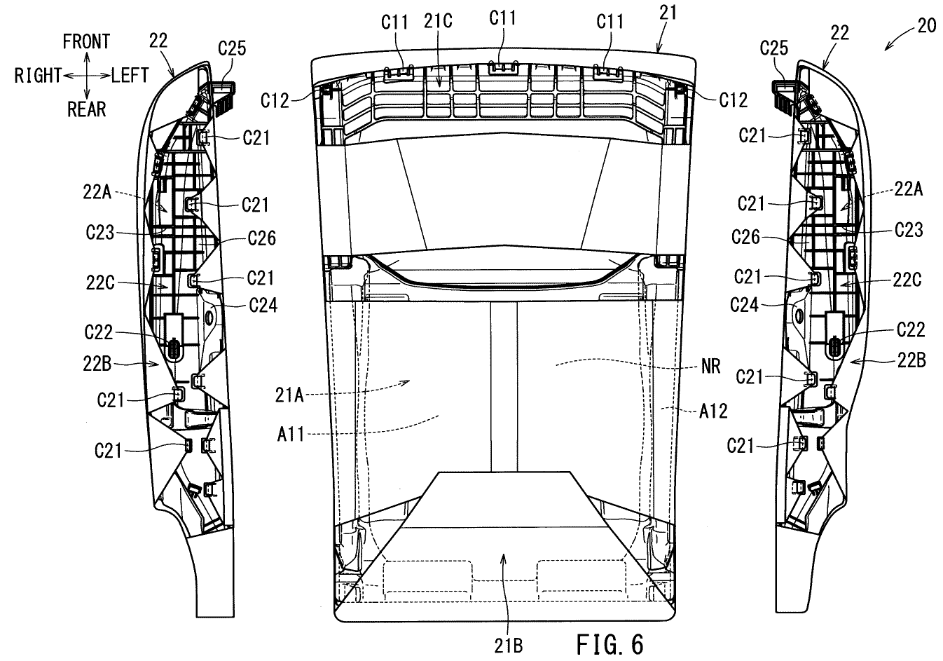

As shown in FIG. 6 to FIG. 8, the main top panel pad 21A has a pad body A11 made of polyurethane foam molding and a pad reinforcement portion A12 made of bead foam molding of expanded polypropylene. For example, the pad reinforcement portion A12 is molded to form a U-shape in plan view. The pad reinforcement portion A12 is set in the foam molding die for the pad body A11. The pad reinforcement portion A12 and the pad body A11 are thus integrally formed into a single piece.

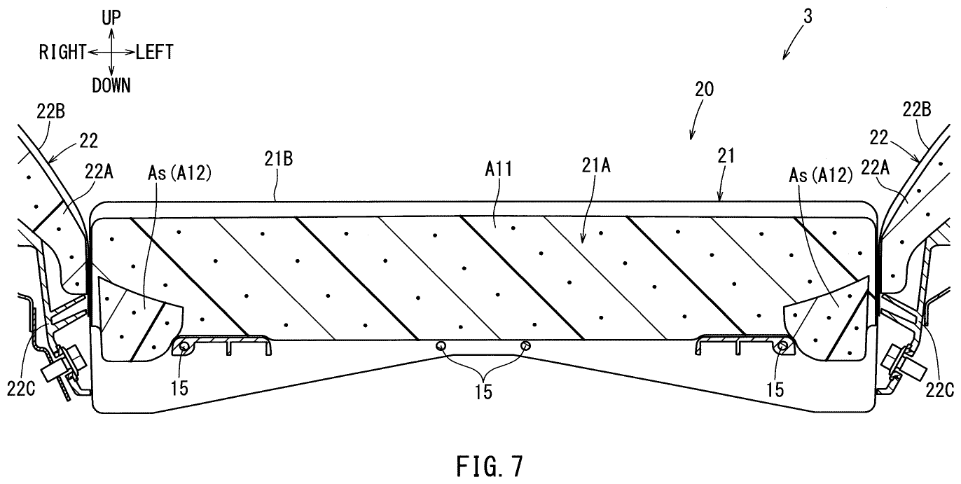

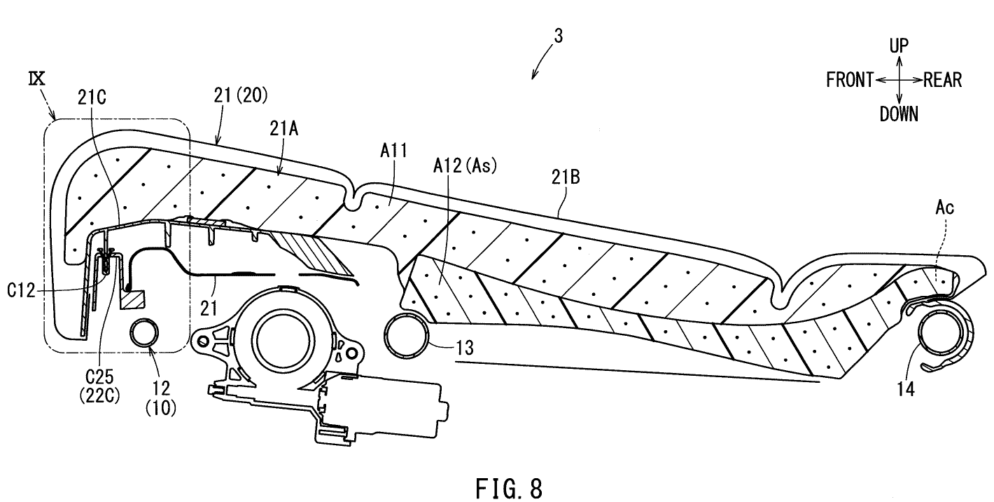

As shown in FIG. 5, the pad reinforcement portion A12 is U-shaped in plan view and has left and right lateral side portions As and a connecting side portion Ac. As shown in FIG. 7 to FIG. 8, the lateral side portions As extend in the seat front-rear direction along both left-right edges (both edges of the back side of the pad) of the back side of the seat of the pad body A11. The connecting side portion Ac extends in the seat width direction so as to connect rear ends of each lateral side portion As. The pad reinforcement portion A12 is harder than the pad body A11. The pad reinforcement portion A12 is provided below and along left and right edges and rear edge of the pad body A11. Therefore, the pad reinforcement portion A12 does not impair cushioning property of the main top panel pad 21. Moreover, the pad reinforcement portion A12 serves to properly suppress lateral sway of the main top panel pad 21.

As shown in FIG. 4, the main top panel 21 is set on the cushion frame 10. As shown in FIG. 8, a front part of each lateral side portion As of the pad reinforcement portion A12 is supported from below by the front pipe 13. The rear of each lateral side portion As is supported by the rear pipe 14.

As shown in FIG. 8, the connecting side portion Ac of the pad reinforcement portion A12 extends along the rear pipe 14 and is supported from below by the rear pipe 14. When the weight of a seater is applied to the main top panel 21, the front part of each lateral side portion As is supported by the front pipe 13, and the rear part of each lateral side portion As and the connecting side portion Ac are supported by the rear pipe 14. The connecting side portion Ac is supported from below the seat over a wide area in the seat width direction by the rear pipe 14.

With these supports, the pad reinforcement portion A12 can properly suppress lateral movement of the main top panel 21 when the vehicle is subjected to lateral acceleration. On the other hand, the pad reinforcement portion A12 is not located on and is not in contact with the tilt panel 12, as shown in FIG. 8. In other words, the pad reinforcement portion A12 is not provided in a front area of the main top panel pad 21A but is provided from an intermediate portion to a rear portion of the main top panel pad 21A in the seat front-rear direction.

As described above, the pad reinforcement portion A12 forms a U-shape in plan view. As a result, the center of the back side of the seat (the center of the back side of the pad) of the pad body A11 is not reinforced with the pad reinforcement portion A12 (non-reinforced portion NR). In other words, the main top panel pad 21A has a non-reinforced portion NR at the center of the back side of the pad. The both side edges and the rear edge of the back side of the main top panel pad 21A include the pad reinforcement portion A12. Therefore, the main top panel pad 21A properly suppresses the lateral sway without impairing the cushioning property.

The main top panel cover 21B is placed over the main top panel pad 21A from above the seat. As shown in FIG. 6, each of the front, rear, left, and right peripheral edges of the main top panel cover 21B is drawn into and securely attached to the back side of the pad, which is a surface of the main top panel pad 21A on the back side of the seat. Specifically, the left and right terminal ends of the main top panel cover 21B, which is drawn into the back side of the pad, are locked to each other to allow the main top panel cover 21B to be securely attached from the intermediate portion to the rear portion in the seat front-rear direction where the pad reinforcement portion A12 of the main top panel pad 21A is provided. The terminal end of the rear edge drawn into the back side of the pad of the main top panel cover 21B is attached to the back side of the pad of the main top panel pad 21A via a hook and loop fastener (not shown).

As shown in FIG. 6, a main top panel resin member 21C in a U-shape in plan view is provided on the back side of pad of the top panel main pad 21A. The main top panel cover 21B is securely attached to the front of the main top panel pad 21A with the left, right and front terminal ends, which are drawn into the back side of the pad, hooked to the main top panel resin member 21C. The above hooking allows the main top panel cover 21B to be stretched over the entire outer surface of the main top panel pad 21A. In addition, the main top panel resin member 21C is secured while being pressed against the back side of the pad of the main top panel pad 21A through the hooking of each terminal end of the main top panel cover 21B.

The main top panel resin member 21C is made of an injection molded product. The main top panel resin member 21C is provided at the front of the back side of the pad, which is a front side of an area where the pad reinforcement portion A12 of the main top panel pad 21A is provided. Specifically, the main top panel resin member 21C is U-shaped in plan view extending along both left and right edges and the front edge at the front of the rear side of the pad of the main top panel pad 21A.

Cover hooking claws C11 are formed on the front edge and right and left edges of the main top panel resin member 21C, the edges extending in a U-shape in plan view. Each terminal end of the main top panel cover 21B, which is drawn into the back side of the pad, is securely attached to the cover hooking claws C11. A fitting claw C12 consisting of an elastic claw protruding downwardly from the seat is attached to both left and right edges of the front edge of the main top panel resin member 21C.

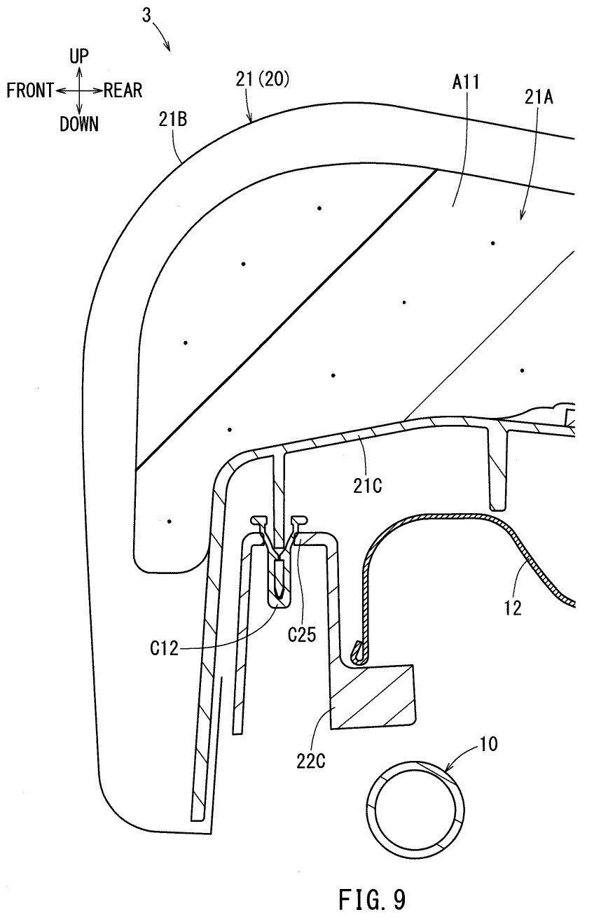

The main top panel 21 is positioned on the cushion frame 10 from above the seat. At this time, as shown in FIG. 8 to FIG. 9, each fitting claw C12 of the main top panel resin member 21C is snap-fitted into the fitted portion C25 of the side top panel 22 such that it is pushed in from above the seat. The side top panel 22 has a side top panel resin member 22C that is assembled to the tilt panel 12. A fitting claw C12 is formed at the front end inner side of the side top panel resin member 22C. This allows the front end of the main top panel 21 to be fitted via each side top panel 22 so that it cannot be released upwardly from the cushion frame 10.

As shown in FIG. 9, the fitting claw C12 is configured to be easily released from the fitted state with the fitted portion C25 of each side top panel 22 when an operator applies force to pull up the front end of the main top panel 21 from below the seat from the snap-fitted state. The fitted portion C25 of each side top panel 22 corresponds to a “base portion” of the present disclosure. To release the main top panel 21, force is applied to pull up the front end of the main top panel 21, releasing the fitting claws C12 from the base portion.

As shown in FIG. 8, the main top panel 21 is assembled to the cushion frame 10 as follows. First, the rear part of the main top panel 21 is inserted so as to enter under the seat back 2 from the front of the seat so as to be set on the rear pipe 14. Next, the front part of the main top panel 21 is lowered down onto the tilt panel 12 with the rear part of the main top panel 21 as a fulcrum.

This causes each fitting claw C12 formed on both edges of a front panel of the main top panel resin member 21C to be snap-fitted to the fitted portion C25 at the front end inner side of each side top panel 22 (see FIG. 9). Thus, the main top panel 21 is removably assembled to the cushion frame 10 in only two states, such as meeting from above the seat and fitting each fitting claw C12 at the front end.

### [Configuration of Each Side Top Panel 22]

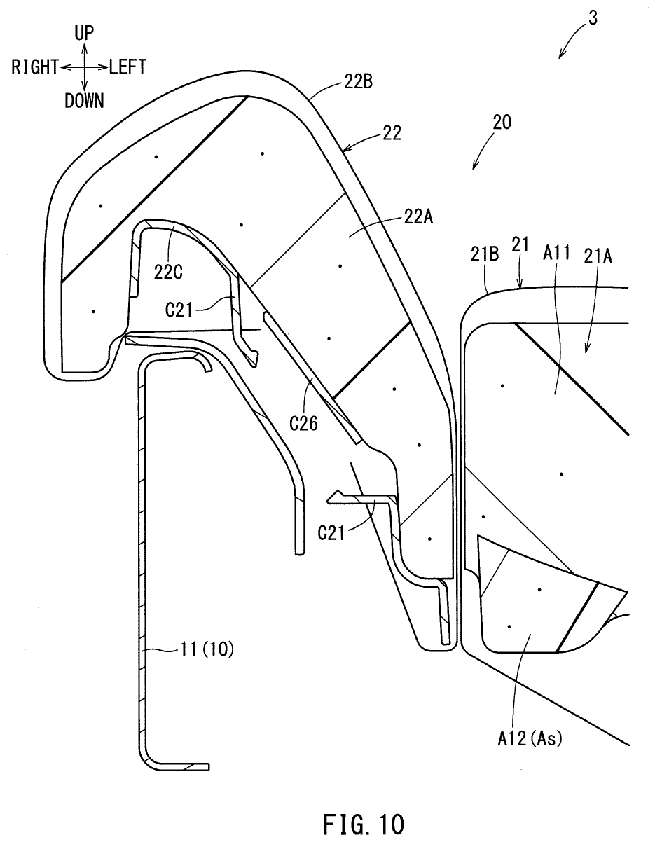

As shown in FIG. 4, FIG. 6, and FIG. 10, each side top panel 22 has a side top panel pad 22A that serves as a cushioning portion, a side top panel cover 22B, and a side top panel resin member 22C, respectively. The side top panel cover 22B is made of fabric and covers the side top panel pad 22A. The side top panel resin member 22C is provided on the back side of the pad of the side top panel pad 22A. Each side top panel 22 is configured to be left-right symmetrical with the same basic structure as each other.

As shown in FIG. 10, the side top panel pad 22A is made of polyurethane foam molding. A pad surface, which is a surface on a front side of the seat of the side top panel pad 22A, has a bank-like extension. Specifically, the pad surface rises from an inside in the seat width direction outwardly to expand diagonally above the seat. The back side of the pad of the side top panel pad 22A is depressed along the bank-like extension at the pad surface. In other words, the back side of the pad is formed in a shape of a depressed curved surface with the back side hollowed out.

As shown in FIG. 10, the side top panel cover 22B is placed over the side top panel pad 22A from above the seat. Each of the front, rear, left and right peripheral edges of the side top panel cover 22B is drawn into and securely attached to the back side of the pad of the side top panel pad 22A. Specifically, as shown in FIG. 6, the left-right, and front-rear terminal ends of the side top panel cover 22B are drawn into the back side of the side top panel pad 22A. Each terminal end of the side top panel cover 22B is then hooked and securely attached to the side top panel resin member 22C provided along the back side of the side top panel pad 22A.

This causes the side top panel cover 22B to be stretched over the entire outer surface of the side top panel pad 22A. The side top panel resin member 22C is then secured while being pressed against the back side of the pad of the side top panel pad 22A through the hooking of each terminal end of the side top panel cover 22B.

As shown in FIG. 6 and FIG. 10, the side top panel resin member 22C is a curved plate-like injection molded product. The side top panel resin member 22C has a shape that matches the depressed curved surface of the back side of the pad of the side top panel pad 22A, providing proper side support for the body of the seater. The side top panel resin member 22C has a side support portion C26 that extends diagonally along the bank-like extension of the side top panel pad 22A. Accordingly, the side support portion C26 planarly supports the bank-like extension of the side top panel side pad 22A from the back side. As a result, the side top panel pad 22A provides proper side support for the body of the seater.

As shown in FIG. 6 and FIG. 10, a cover hooking claw C21 is formed on a peripheral edge of the side top panel resin member 22C. Each terminal end of the side top panel cover 22B, which is drawn into the back side of the pad of the side top panel cover 22B, is securely attached to the cover hooking claws C11. As shown in FIG. 6, a hook-like engagement claw C22 is formed in a substantial center region of the side top panel resin member 22C. The engagement claw C22 protrudes downwardly from an upper region of the depressed curve of the side top panel resin member 22C. When the side top panel 22 is assembled to the cushion frame 10 (see FIG. 11) from above, the engagement claw C22 is inserted from above into the engagement hole Ah formed in the top panel portion of the tilt arm 12A.

Next, the side top panel 22 is slidably moved rearward with respect to the cushion frame 10 to cause the engagement claw C22 to be hooked into the engagement hole Ah from the front. This hooking secures the side top panel 22 to the tilt arm 12A so as not to be pulled out above the seat.

As shown in FIG. 6, a guide portion C23 is formed on a lower surface of the side top panel resin member 22C. The guide portion C23 is located in the upper region of the depressed curve of the side top panel resin member 22C. The guide portion C23 is L-shaped in cross section and has a substantially horizontal portion and a protruding portion protruding downwardly from the horizontal portion. By assembling the side top panel 22 to the cushion frame 10 (see FIG. 11) from above, the horizontal portion of the guide portion C23 contacts the upper surface of the top panel portion of the tilt arm 12A. The protruding portion of the guide portion C23 contacts an outer edge of the top panel portion of the tilt arm 12A. Thereby, the guide portion C23 restricts an assembly position of the side top panel 22 to the cushion frame 10 in the seat width direction.

As shown in FIG. 11 to FIG. 13, a plate-like fastening portion C24 is formed in an intermediate portion of the side top panel side resin member 22C in the seat front-rear direction. The fastening portion C24 extends diagonally downward from an inside edge of the side top panel resin member 22C in the width direction toward the inside of the width direction. The fastening portion C24 is laid on an upper surface of the fastening bracket Ab when the side top panel 22 is assembled to the cushion frame 10.

Next, as shown in FIG. 13, a bolt T1 having a plug-in type fastening structure T, is inserted into and fastened to the fastening portion C24 and the fastening bracket Ab using a fastening tool D (impact tool). Thereby, the fastening portion C24 is fastened to the fastening bracket Ab.

Specifically, as shown in FIG. 13, the fastening structure T consists of the bolt T1 and a weld nut T2 welded to a lower surface (the surface opposite to an upper surface) of the fastening bracket Ab. A head T1h of the bolt T1 is set on the fastening tool D as a tool engaging portion. A leg of the bolt T1 is inserted through the fastening portion C24 and the overlapping fastening bracket Ab and fastened to the weld nut T2 by the fastening tool D.

The fastening bracket Ab and the overlapping fastening portion C24 are oriented with an upper surface to the opening SP, which is an installation space for the main top panel 21. Therefore, during fastening operation of the bolt T1 using the fastening tool D, the opening SP can be used as a workspace for easy access to the fastening point. More specifically, the fastening operation can be performed by inserting only an end of the fastening tool D diagonally into the fastening point without lowering an entire fastening tool D down into the opening SP.

In this configuration, the support spring 15 is assembled in the cushion frame 10 laterally in alignment with the fastening points. Even with this configuration, the fastening operation can be performed without interfering the fastening tool D with the support spring 15. With the above fastening, the head T1h (tool engaging portion) of the bolt T1 is provided with its upper surface oriented to the opening SP, which is the installation space for the main top panel 21. Therefore, when removing the bolt T1 from the fastened state, the fastening tool D may be inserted diagonally through the opening SP in the same manner to easily perform the loosening operation of the bolt T1.

### [Assembly Method of Seat Cushion 3]

Subsequently, a method for assembling the cushion body 20 to the cushion frame 10 will be described. As shown in FIG. 11 to FIG. 13, before assembling the main top panel 21 to the cushion frame 10, each side top panel 22 is assembled to the cushion frame 10 (side top panel assembling process). The method for assembling each side top panel 22 to the cushion frame 10 is as described above.

Next, the main top panel 21 is assembled to the cushion frame 10 (main top panel assembling process). This method allows for the cushion body 20, consisting of three separate elements (main top panel 21 and side top panels 22), to be easily and properly assembled to the cushion frame 10. The reverse of this method is used for dissembling the cushion body 20 from the cushion frame 10.

In summary, the seat 1 and the method for assembling the same according to the present embodiment are configured as follows. Hereinafter, the reference numerals in parentheses are the reference numerals corresponding to the respective configurations described in the above embodiments.

As shown in FIG. 2, the seat (1) has a cushion body (20) that elastically supports a seater and a seat frame (10) that supports the cushion body (20) from a rear side of the seat. As shown in FIG. 4, the cushion body (20) includes three separate elements such as a main top panel (21), which forms the center portion in the seat width direction, and each side top panel (22), which forms both side portions in the seat width direction. Each side top panel (22) has a side top panel pad (22A) that serves as a cushioning portion and a support member (22C). As shown in FIG. 13, the support member (22C) is located on a back side of the side top panel pad (22A) and is fixed to the seat frame (10).

As shown in FIG. 13, the seat frame (10) has each side frame (12A) and each frame fastening portion (Ab). Each side frame (12A) supports each side top panel (22) from the back side of the seat. Each support member (22C) is laid on each frame fastening portion (Ab), and each support member (22C) is fastened to each frame fastening portion (Ab) via a plug-in type fastening structure (T). Each support member (22C) is integral with each side frame (12A). As shown in FIG. 4, the main top panel (21) is removably attached to the seat frame (10) by snap-fitting. In a main top panel removed state, in which the main top panel (21) is removed from the seat frame (10), each support member (22C) is laid on each frame fastening portion (Ab). As shown in FIG. 13, the tool engaging portion (T1h) to be engaged with the fastening tool (D) having each plug-in type fastening structure (T) is exposed to the outside through the opening (SP) that is an installation space for the main top panel (21).

According to the above configuration, the main top panel (21) is snap-fitted to the seat frame (10). Therefore, the main top panel (21) can be relatively easily removed from the mounted state on the seat frame (10). When the main top panel (21) is removed from the seat frame (10), the tool engaging portion (T1h) is exposed to the outside through the opening (SP), which is the installation space for the main top panel (21). Therefore, each side top panel (22) may be easily attached and removed without needing to remove the seat (1) from the vehicle or object it is installed. Specifically, the opening (SP) can be used as a workspace for fastening and loosening the plug-in type fastening structure (T) using the fastening tool (D).

As shown in FIG. 13, each frame fastening portion (Ab) extends diagonally backward from each corresponding side frame (12A) to the inner side in the seat width direction, respectively. Each frame fastening portion (Ab) has an overlapping surface (upper surface) on which each of the corresponding support members (22c) is laid on. A direction perpendicular to the overlapping surface is oriented toward the opening (SP). According to the above configuration, each frame fastening portion (Ab) is provided in such an orientation as to allow the plug-in type fastening structure (T) to be inserted diagonally from the opening (SP). Therefore, each side top panel (22) can be easily attached and removed even in a configuration with restrictions that make it difficult to lower the fastening tool (D) down between the seat frames (10) for reasons such as the support spring (15) for supporting the cushion body (20) being provided between the seat frames (10).

As shown in FIG. 11, each support member (22C) further includes an engagement claw (C22). The engagement claw (C22) is inserted and slidably moved in the engagement hole (Ah) formed in each corresponding side frame (12A). Thereby, the engagement claw (C22) is hooked to a bore edge of the engagement hole (Ah). In this state, each support member (22C) is fastened to each frame fastening portion (Ab) through each plug-in type fastening structure (T).

According to the above configuration, the side top panel (22) is assembled to the seat frame (10) through hooking by sliding the engagement claw (C22) and fastening with the plug-in type fastening structure (T). Compared to a snap-fit assembly configuration involving elastic deformation, this assembly allows each side top panel (22) to be easily assembled to each side frame (12A) with appropriate assembly strength. Furthermore, removal can also be performed easily.

As shown in FIG. 13, the tool engaging portion (T1h) of each plug-in type fastening structure (T) has a head (T1h) of a bolt (T1). The head (T1h) is located on the side of each plug-in type fastening structure (T) closest to the opening (SP). According to the above configuration, a shaft of the bolt (T1) is not oriented to the opening (SP). Therefore, the bolt (T1) provided in the cushioning body (20) is less likely to be perceived as a foreign object.

As shown in FIG. 9, the main top panel (21) has a fitting claw (C12). The fitting claw (C12) is removably snap-fitted to the base portion (C25), which is integral with the seat frame (10), by being pressed from the front side of the seat. The main top panel (21) meets the seat frame (10) from the front side of the seat, and the fitting claw (C12) fits into the seat frame (10). In other words, the main top panel (21) is removably assembled to the seat frame (10) in only two states. According to the above configuration, the main top panel (21) can be easily attached to and removed from the seat frame (10).

The assembly method for assembling the above-described seat (1) involves placing respective side top panels (22) with these respective support members (22C) on the corresponding respective frame fastening portions (Ab). Each side top panel (22) is assembled to the seat frame (10) by fastening each plug-in type fastening structure (T) (side top panel assembling process). Next, the main top panel (21) is assembled to the seat frame (10) (main top panel assembling process). According to the above configuration, the side top panel assembling process is performed before the main top panel assembling process. As a result, the opening (SP), which is the installation space for the main top panel (21), serves as a workspace. Using this workspace, each side top panel (22) can be easily assembled to the seat frame (10).

### Other Embodiments

Although one embodiment of the present disclosure has been described above, the present disclosure may be implemented in various other embodiments than the above-described embodiments.

The seat of the present disclosure may be installed in vehicles other than automobiles, such as trains. Alternatively, the seat may be installed in transportation means other than vehicles, such as aircraft or ships. As mentioned above, the configuration of the present disclosure may be applied to a seat cushion or a seatback.

The support members provided on each side top panel may be made of resin or metal. Moreover, one or more support members may be provided for each side frame of the seat frame. The support members may be configured using clip insertion or screw fastening.

The support member may be a plug-in type fastening structure consisting of a bolt-nut combination or the like. In this case, the bolt may be welded to the frame fastening portion of each side frame. The nut may then be fastened to a shaft of the bolt using a fastening tool. Neither the bolt nor the nut may be welded to the frame fastening portion of each side frame. Each of the bolt and nut may be fastened to each side frame and other parts during assembly.

The frame fastening portion (Ab) shown in FIG. 11 was a separate component from the other parts of each side frame. For example, the frame fastening portion is fixed to the other parts of the side frames integrally by welding or bolt-fastening. Alternatively, the frame fastening portion may be made of the same component as the other parts of the side frames. The frame fastening portion shown in FIG. 11 extends diagonally backward from each side frame to the inner side in the seat width direction. Alternatively, the frame fastening portion may extend straight from each side frame to the back side of the seat, straight inward in the seat width direction, or in a bent shape in a combination thereof.

The fitting claw C12 shown in FIG. 9 is snap-fitted to the fitted portion C25 (base member) of the side top panel 22. The base member may be the seat frame itself or another member to be provided on the seat frame. The main top panel cover and side top panel cover may be made of leather material as well as fabric, respectively.

1. A seat comprising:
a seat frame; and
a cushion body configured to be supported by the seat frame from a back side and the cushion body configured to elastically support a seater,
wherein the cushion body includes three separate elements divided into a main top panel that forms a center portion in a seat width direction and two side top panels that form two side portions in the seat width direction,
wherein each of the side top panels has a side top panel pad and a support member disposed on a back side of the side top panel pad and fixed to the seat frame,
wherein the seat frame has each side frame configured to support each of the side top panels from a back side of the seat, and each frame fastening portion integrally formed with each of the side frames,
wherein each of the support members is overlaid on each of the frame fastening portions, each of the support members being fastened to each of the frame fastening portions via a plug-in type fastening structure,
wherein the main top panel is removably attached to the seat frame by snap-fitting, and
wherein an opening, which serves as an installation space for the main top panel, is created in a main top panel removed state with the main top panel being removed from the seat frame, and a tool engaging portion of each of the plug-in type fastening structures is exposed through the opening.

2. The seat according to claim 1, wherein:
each of the frame fastening portions extends diagonally backward from each of the corresponding side frames to an inner side in the seat width direction,
each of the frame fastening portions has an overlapping surface on which each of the corresponding support members is laid, and
a direction perpendicular to the overlapping surface is oriented towards the opening.

3. The seat according to claim 1, wherein:
an engagement hole is formed in each of the side frames,
each of the support members further includes an engagement claw, and
the engagement claw is inserted into the engagement hole and slidably moved so as to be hooked to the side frame.

4. The seat according to claim 1, wherein:
the tool engaging portion has a head of bolt, and
the head of bolt is located on a side of each plug-in type fastening structure closest to the opening.

5. The seat according to claim 1, wherein:
a base portion is provided to be integral with the seat frame,
the main top panel has a fitting claw, and
the fitting claw is removably snap-fitted to the base portion upon being pressed from a front side of the seat.

6. An assembly method for assembling the seat according claim 1, the method comprising:
assembling the side top panels, comprising:
placing each of the support members of each of the side top panels to each of corresponding frame fastening portions; and
fastening each of the support members to the seat frame using plug-in type fastening structures; and
assembling the main top panel to the seat frame.

7. The assembly method of claim 6, wherein the plug-in type fastening structure includes a bolt and a weld nut, wherein the bold is inserted into a fastening portion of the support member and the overlapping one of the frame fastening portions and fastened to the weld nut using a fastening tool.

8. The assembly method of claim 6 further comprising assembling the side top panel to the side frame by inserting an engagement claw of the side top panel into an engagement hole of the side frame, and the engagement claw is slidably moved to hook onto the side frame.

9. A seat comprising
a seat frame; and
a cushion body having a main top panel that is removably attached to the seat frame by snap-fitting and two side top panels, wherein each of the side top panels has a side top panel pad and a support member, and wherein the support member is disposed on a back side of the side top panel pad.

10. The seat of claim 9, wherein the main top panel has a main top panel pad, a main top panel cover, and a main top panel resin member.

11. The seat of claim 9, wherein the main top panel is positioned on the cushion body from above the seat.

12. The seat of claim 9, wherein the seat frame has a side frame configured to support each of the side top panels from the back side of the seat and a frame fastening portion configured to integrate with the side frame.

13. The seat of claim 12, wherein the support member is overlaid on the frame fastening portion and fastened to the frame fastening portion via a plug-in type fastening structure.

14. The seat of claim 13, wherein the plug-in type fastening structure includes a bolt and a weld nut, wherein the bolt is inserted into a fastening portion of the support member and the bolt is inserted into the frame fastening portion overlapping the fastening portion for fastening the weld nut.

15. The seat of claim 9, wherein the main top panel is configured to be removably attached to the seat frame by a snap-fitting mechanism.

16. The seat of claim 9, wherein the main top panel further has a fitting claw that is removably snap-fitted to a base portion integral with the seat frame when being pressed from a front side of the seat.

17. The seat of claim 16, wherein the fitting claw is located on a main top panel resin member of the main top panel.
